(19) United States
(12) Patent Application Publication
(10) Pub. No.: US 2026/0313382 A1
(43) Pub. Date: Oct. 8, 2026

(54) THREAT MITIGATION

(71) Applicant: Telefonaktiebolaget LM Ericsson (publ), Stockholm (SE)

(72) Inventors: Rodrigo ALVAREZ DOMINGUEZ, Madrid (ES); Miguel Angel MUÑOZ DE LA TORRE ALONSO, Madrid (ES)

(21) Appl. No.: 19/481,393

(22) PCT Filed: Aug. 31, 2023
(86) PCT No.: PCT/EP2023/073925

§ 371 Date: Nov. 4, 2025

(30) Foreign Application Priority Data
May 5, 2023 (EP) 23382416.8

(51) Int. Cl. H04W 12/122

(52) U.S. Cl. CPC H04W 12/122

(57) ABSTRACT

A method at a user plane entity handling data packet traffic in a cellular network is provided. The user plane entity receives a first data packet traffic originating from a user equipment connected to the cellular network, determines that the first data packet traffic is a suspicious data packet traffic considered as potentially causing harm and transmits a policy request to the user equipment. The policy request includes a traffic identifier of the first data packet traffic and a policy how to handle the first data packet traffic at the user equipment. The policy request requests an application of the policy to the first data packet traffic.

### TECHNICAL FIELD

The present application relates to a method carried out at a user plane entity, to a method carried out at a user equipment, and to the corresponding user plane entity and user equipment. Furthermore a system is provided comprising the user plane entity and the user equipment, a computer program comprising program code and a carrier comprising the computer program.

### BACKGROUND

FIG. 1 shows a 5G New Radio, NR, architecture with service based interfaces in the Service Based Architecture (SBA). Service Based Interfaces are represented in the format Nxyz, such as Nsmf.

The 5G core network comprises a Unified Data Repository, UDR, 10, a Network Exposure Function (NEF) 11, Network Data Analytics Function, NWDAF, 12, an Application Function (AF) 13, a Policy Control Function (PCF) 14, a Charging Function, CHF, 15 an Access and Mobility Management Function (AMF) 16, and a Session Management Function (SMF) 17. Having service based interfaces in the 5G Core Control Plane (CP), implies that the Network Functions (NFs) in the 5G Core CP provide services that are consumed by other NFs in the 5G Core CP.

In the following the more relevant architectural aspects for the present application are explained in more detail.

The NWDAF 12 represents operator managed network analytics logical function. The NWDAF is part of the 5GC architecture and uses the mechanisms and interfaces specified for 5GC and OAM.

The NWDAF interacts with different entities for different purposes:
Data collection based on event subscription, provided by AMF, SMF, PCF, UDM, AF (directly or via NEF), and OAM;
Retrieval of information from data repositories (e.g. UDR via UDM for subscriber-related information);
Retrieval of information about NFs (e.g. NRF for NF-related information, and NSSF for slice-related information);
On demand provision of analytics to consumers.

A single instance or multiple instances of NWDAF may be deployed in a PLMN. If multiple NWDAF instances are deployed, the architecture supports deploying the NWDAF as a central NF, as a collection of distributed NFs, or as a combination of both. If multiple NWDAF instances are deployed, an NWDAF can act as an aggregate point (i.e. Aggregator NWDAF) and collect analytics information from other NWDAFs, which may have different Serving Areas, to produce the aggregated analytics (per Analytics ID), possibly with Analytics generated by itself. When multiple NWDAFs exist, not all of them need to be able to provide the same type of analytics results, i.e. some of them can be specialized in providing certain types of analytics. An Analytics ID information element is used to identify the type of supported analytics that NWDAF can generate. NWDAF instance(s) can be collocated with a 5GS NF (e.g. UPF).

The UDR 10 stores data grouped into distinct collections of subscription-related information:
Subscription Data;
Policy Data;
Structured Data for Exposure;
Application Data.

The PCF 14 supports a unified policy framework to govern the network behavior. Specifically, the PCF provides PCC (Policy and Charging Control) rules to the PCEF (Policy and Charging Enforcement Function), i.e. the SMF/UPF that enforces policy and charging decisions according to provisioned PCC rules.

The SMF 17 supports different functionalities, e.g. SMF receives PCC rules from the PCF and configures the UPF accordingly.

The UPF supports handling of user plane traffic, including packet inspection, packet routing and forwarding, traffic usage reporting, QoS handling for user plane (e.g. UL/DL rate enforcement).

Furthermore the problem of security related attacks in mobile networks are known and are causing more and more trouble.

There is a broad family of well-known security attacks in mobile networks and can be classified into:
Passive attacks (Wiretapping, Port scan, Idle scan)
Active attacks:
Denial-of-Service attack

DDoS: According to Wikipedia, in computing, a denial-of-service attack (DoS attack) is a cyber-attack where the perpetrator seeks to make a machine or network resource unavailable to its intended users by temporarily or indefinitely disrupting services of a host connected to the Internet. Denial of service is typically accomplished by flooding the targeted machine or resource with superfluous requests to overload systems and to prevent some or all legitimate requests from being fulfilled.

In a distributed denial-of-service attack (DDoS attack), the incoming traffic flooding the victim originates from many different sources. This effectively makes it impossible to stop the attack simply by blocking a single source.

There are different types of DDoS attacks:
Volume-based attacks, which use high traffic to inundate the network bandwidth.
Protocol attacks, which focus on exploiting server resources.
Application attacks, which focus on web applications and are considered the most sophisticated and serious type of attacks.

As popular types of DDoS attacks: SYN flood, UDP flood, HTTP flood, Ping of death, Smurf attack, Fraggle attack, Slowloris, NTP amplification, Advanced Persistent DoS, Zero-day DDoS attacks, etc.
Spoofing. Volume based: spoofing, UDP (DNS), ICMP, reflection amplification
Network (Man in the middle, ARP poisoning, Ping flood, Ping of death, Smurf attack).
Host (Buffer overflow, Heap overflow, Stack overflow, Format string attack).

Botnet is a network of internet-connected devices that are infected and remotely controlled by malware. A botnet occurs when an attacker, called a bot-herder, takes control of a network of computers and infects them with malware. A botnet enables a single attacker to use a centrally controlled network of multiple devices to carry out a coordinated cyber-attack.

In the context of network attacks several problems can be identified such as the fact that the mobile network operator policies related to traffic management are currently enforced at the mobile network operator such as the UPF, but are not enforced at endpoints. The mobile network operators are furthermore challenged in view of the exponential increase of connected devices, both mobile broadband IoT devices which implies a higher probability of security threats and vulnerabilities. Furthermore, the existing gateways such as UPFs provide some basic security functions like DDoS detection. However, the mitigation actions are very limited as the time to mitigation is not aligned with the 5G risks, such as a 100 ms response time.

The mitigation is based on access control such as the blocking of traffic at the gateway which implies however the RAN resources can be exhausted due to undesired traffic resulting from a DDoS attack all UEs such as IoT devices involved in the DDoS attack are consuming radio access network, RAN, resources and if all of them are in the same zone, they can perform an DDoS attack for radio resources impacting other non-malicious devices in the same zone.

### SUMMARY

Accordingly, a need exists to overcome the above identified problems and to provide a possibility to decrease the influence in the cellular network which occurs when a security-related attack is detected for the mobile network.

This need is met by the features of the independent claims. Further aspects are described by the dependent claims.

According to a first aspect, a method carried out at a user plane entity is provided which handles data packet traffic in a cellular network wherein the method comprises the step of receiving a first data packet traffic originating from a user equipment connected to the cellular network. The user plane entity determines that the first data packet traffic is a suspicious data packet traffic considered as potentially causing harm. Furthermore a policy request is transmitted to the user equipment which includes a traffic identifier of the first data packet traffic, and which includes a policy how to handle the first data packet traffic at the user equipment. The policy request requests an application of the policy to the first data packet traffic.

Furthermore, the corresponding user plane entity handling the data packet traffic is provided. A network function, here the user plane entity has a fast and efficient option to cope with security-related attacks as the user plane entity itself can directly request the UE to apply a certain service and policy so that the first data packet traffic which is considered a suspicious data packet traffic is either stopped at the UE or reduced. The policy request can include requests such as the blocking of the first data packet traffic, the reduction of the transmission time window or simply the notification of a user of the user equipment that the data packet traffic is considered as being a potentially harmful traffic.

Furthermore, a method carried out at the user equipment is provided which is connected to the cellular network, wherein the user equipment transmits a first data packet traffic considered as suspicious data packet traffic which potentially causes harm. The user equipment furthermore receives the policy request from the user plane entity which handles the first data packet traffic in the cellular network and the policy request includes a traffic identifier of the first data packet traffic and a policy how to handle the first data packet traffic at the user equipment. The policy request furthermore requests an application of the policy to the first data packet traffic. The user equipment then applies the policy received in the request to the first data packet traffic.

Furthermore, the corresponding user equipment is provided configured to operate as discussed above or as discussed in further detail below. The user equipment receives a policy from the user plane entity how to handle the first data packet traffic and it applies the policy as received.

Furthermore a system is provided comprising the user plane entity and the user equipment. In addition, a computer program comprising program code is provided to be executed by at least one processing unit of a user plane entity or of a user equipment where execution of the program code causes the at least one processing unit of the user plane entity or the user equipment to carry out a method as mentioned above or as discussed in further detail below. Finally, a carrier is provided comprising the computer program, wherein the carrier is one of an electronic signal, optical signal, radio signal, and computer-readable storage medium.

It is to be understood that the features mentioned above and features yet to be explained below can be used not only in the respective combinations indicated, but also in other combinations or in isolation without departing from the scope of the present invention. Features of the above-mentioned aspects and embodiments described below may be combined with each other in other embodiments unless explicitly mentioned otherwise.

### BRIEF DESCRIPTION OF THE DRAWINGS

FIG. 1 shows a schematic representation of a network architecture in which the present invention can be used.

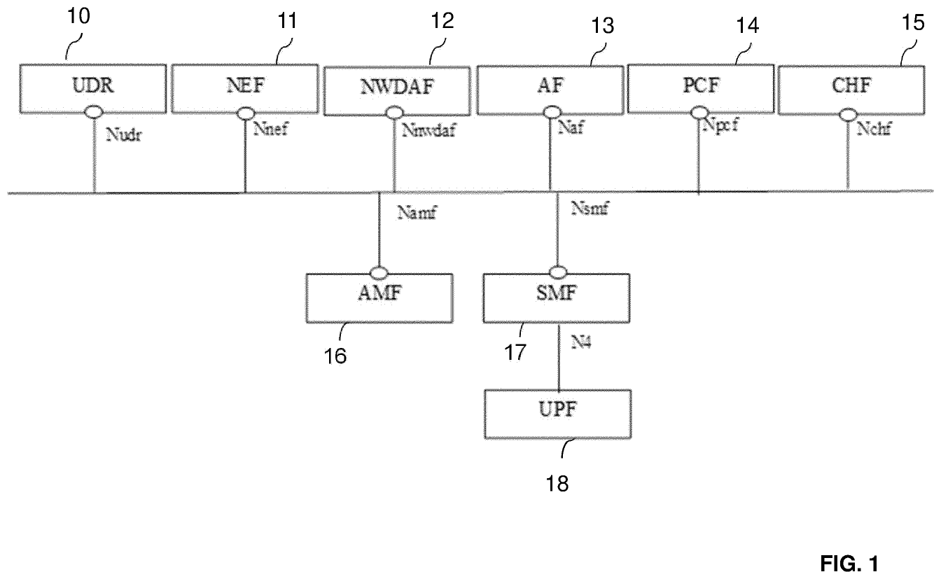

FIGS. 2a and 2b show an example representation of a message exchange between the involved entities where a user plane entity controls a data packet flow issued by a user equipment.

FIGS. 3a and 3b show a further schematic representation of a message exchange between the involved entities where a user plane entity controls a data packet traffic transmitted by a user equipment.

FIG. 4 shows an example flowchart of a method carried out as a user plane entity in a situation discussed in connection with FIGS. 2 and 3.

FIG. 5 shows an example flowchart of a method carried out at a user equipment in a situation discussed in connection with FIGS. 2 and 3.

FIG. 6 shows an example representation of a user plane entity handling the data packet traffic in a situation configured to control a data packet traffic transmitted by a user equipment.

FIG. 7 shows an example representation of a user equipment involved in the message exchange discussed in connection with FIGS. 2 to 5.

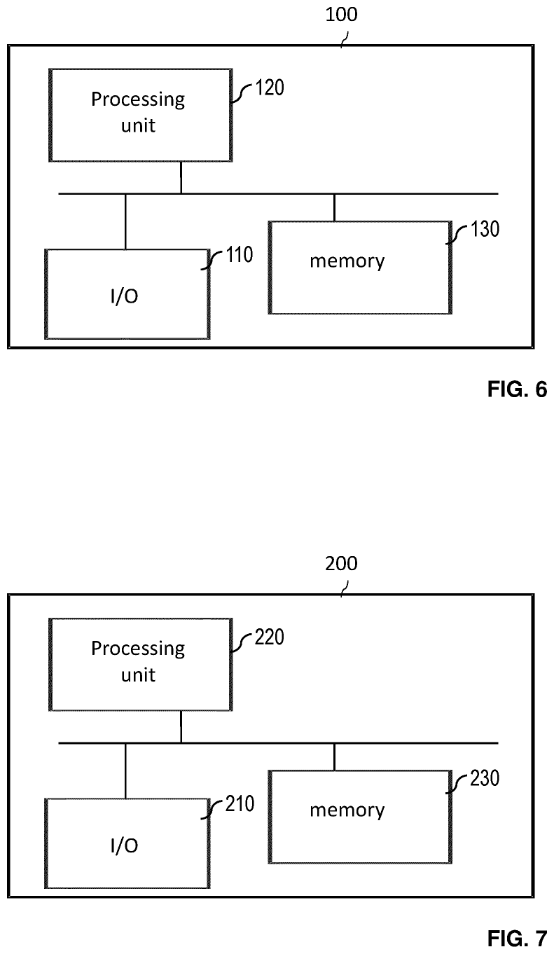

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

Within the context of the present application, the term “mobile entity” or “user equipment” (UE) refers to a device for instance used by a person (i.e. a user) for his or her personal communication. It can be a telephone type of device, for example a telephone or a Session Initiating Protocol (SIP) or Voice over IP (VoIP) phone, cellular telephone, a mobile station, cordless phone, or a personal digital assistant type of device like laptop, notebook, notepad, tablet equipped with a wireless data connection. The UE may also be associated with non-humans like animals, plants, or machines. A UE may be equipped with a SIM (Subscriber Identity Module) or electronic-SIM comprising unique identities such as IMSI (International Mobile Subscriber Identity), TMSI (Temporary Mobile Subscriber Identity), or GUTI (Globally Unique Temporary UE Identity) associated with the user using the UE. The presence of a SIM within a UE customizes the UE uniquely with a subscription of the user.

For the sake of clarity, it is noted that there is a difference but also a tight connection between a user and a subscriber. A user gets access to a network by acquiring a subscription to the network and by that becomes a subscriber within the network. The network then recognizes the subscriber (e.g. by IMSI, TMSI or GUTI or the like) and uses the associated subscription to identify related subscriber data. A user is the actual user of the UE, and the user may also be the one owning the subscription, but the user and the owner of the subscription may also be different. E.g. the subscription owner may be the parent, and the actual user of the UE could be a child of that parent.

The solution discussed below defines a new policy service for a user equipment which can be consumed by a mobile network operator network function such as a user plane entity, also called user plane function and which allows a mobile network operator to request a UE to apply policies at the source. The UE where the policies are applied, can implement the access control to the cellular network as requested, such as the blocking of a traffic, a reduction of the transmission window or a notification of a user of the user equipment. The solution discussed can support a fast and efficient mitigation of attacks as user plane entity itself can directly react to the data packet traffic.

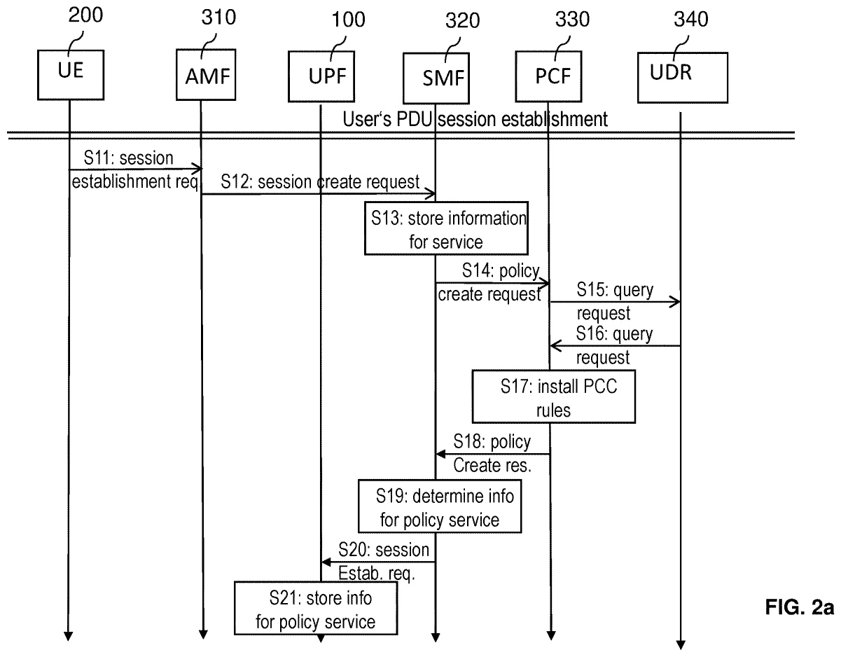

In connection with FIGS. 2a and 2b a fast and efficient mitigation of DDoS attacks (by means of Nue_Policy service) is discussed. Steps are detailed below:
Step 11) UE 200 triggers PDU session establishment, by means of sending a N1 PDU Session Establishment Request to AMF 310, and including the following information:
SUPI. Indicates UE identity.
Indication of support for Nue_Policy service. It indicates that the UE supports a policy related service (Nue_Policy)
Nue_Policy service related information. This includes information related to discovery (e.g. port where UE policy service is listening) and related to the specific policies supported by UE (e.g. block traffic).

As an alternative (not shown in FIG. 2), UE might register the Nue_Policy service in NRF (Network Repository Function)
Step 12) AMF 310 selects an SMF 320 to manage the PDU session and triggers Nsmf PDU Session Create Request including the above information (Indication of support for Nue_Policy service, Nue_Policy service related information).

The sequence diagram in FIGS. 2a and 2b does not include all the signaling messages involved in the PDU Session Establishment procedure. The relevant signaling messages for the invention are described in subsequent steps.
Step 13) SMF 320 stores the information related to Nue_Policy service.
Step 14) SMF 320 triggers towards PCF 330 a Npcf_SMPolicyControl_Create Request message to retrieve SM (Session Management) policies for the user PDU session.
Step 15) PCF 330 triggers towards UDR 340 a Nudr_Query Request message to retrieve the policy data for this user's PDU session.
Step 16) UDR 340 answers PCF 330 with Nudr_Query Response message including the Subscriber Policy Data.
Steps 17) and 18) Based on the above Subscriber Policy Data, PCF 330 installs PCC (Policy Charging Control) rules for the session.
Steps 19) and 20) SMF 320 sends to UPF 100 in the PFCP Session Establishment Request message the PDRs/FAR/QERs/URRs (Packet Data Rules, Forwarding Action Rule, Quality of Service Enforcement Rules, Usage Reporting Rules) and the stored information (at Step 13) related to Nue_Policy service.
Step 21) UPF 100 stores the information related to Nue_Policy service.
Step 22) as shown in FIG. 2b, UPF 100 answers the message in Step 20 indicating successful operation.
Step 23) SMF 320 answers the message in Step 12 indicating successful operation.
Step 24) AMF 310 answers the message in Step 11 indicating successful operation.
Steps 25 and 26) A (malicious) application at UE triggers multiple TCP (Transmission Control Protocol) SYN (Synchronise) messages (i.e. this is a type of DDoS attack aimed to consume network and/or server resources).
Step 27) UPF 100 detects a DDoS attack. The detection can be based on internal logic at UPF, on a NWDAF instance collocated with the UPF instance or on an embedded or external Security SF, e.g. Packet Core Firewall (PCFW) product. As an example of DdoS detection logic:
In case any of the following protocol metrics (TCP in the example) conditions are met:
“Simultaneous TCP SYN” exceeds a configured threshold, AND/OR
“SYN volume” exceeds a configured threshold, AND/OR
“Unacked SYN volume” exceeds a configured threshold.
UPF 100 detects the flows (5-tuples) where the above protocol metrics values have exceeded the configured thresholds.
Step 28) Based on the above, UPF decides to trigger mitigation action/s at the source (UE) and triggers a Nue_Policy request (HTTPS POST) message towards UE (using the Nue_Policy service related information stored in Step 21 above) including the following information:
TrafficDescriptor, which includes the 5-tuples detected in Step 27 above.
RequestedPolicy, which indicates to UE the policy to be applied (e.g. block traffic or reduce the transmission window for the traffic matching the TrafficDescriptor).

For simplicity reasons, FIG. 2 shows a single UE, but in case of a DdoS attack, the mitigation action can be triggered towards all affected Ues.
Step 29) UE answers the message in Step 28 indicating successful operation.
Step 30) UE applies the requested policy (e.g. block) to traffic matching TrafficDescriptor.

In the situation discussed above the user plane entity can ask the user equipment to block the identified traffic.

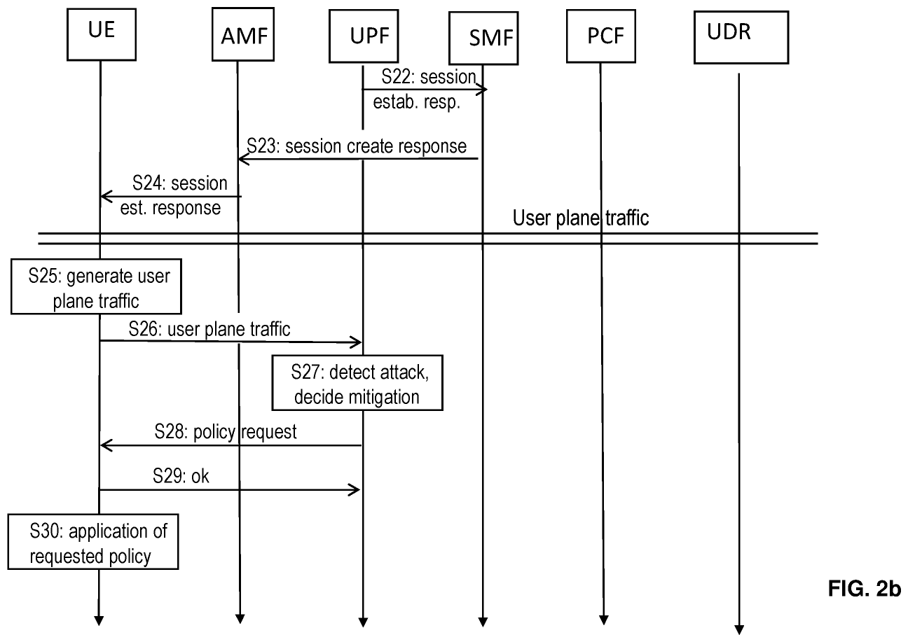

In connection with FIG. 3 a similar embodiment is disclosed in which a user of the user equipment is informed that the user equipment may carry out an attack such as a passive attack, by way of example a port scanning, the port scanning being a method where a UE sends packets to specific ports and uses the response to find any vulnerabilities.

The sequence diagram of the proposed solution is shown in FIGS. 3a and 3b and shows the Use Case example of user notification related to MNO detection of UE security vulnerability. Steps 31 to 44 are similar to steps 11 to 24 discussed in connection with FIG. 2.
Step 31) UE 200 triggers PDU session establishment, by means of sending a N1 PDU Session Establishment Request to AMF, and including the following information:
SUPI. Indicates UE identity.
Indication of support for Nue_Policy service. Indicates UE supports a policy related service (Nue_Policy)
Nue_Policy service related information. This includes information related to discovery (e.g. port where UE policy service is listening) and related to the specific policies supported by UE (e.g. user notification).

As an alternative (not shown in FIG. 3), UE might register the Nue_Policy service in NRF.
Step 32) AMF 310 selects an SMF to manage the PDU session and triggers Nsmf PDU Session Create Request including the above information (Indication of support for Nue_Policy service, Nue_Policy service related information).

Note the sequence diagram in FIG. 3 does not include all the signaling messages involved in the PDU Session Establishment procedure. The relevant signaling messages for the invention are described in subsequent steps.
Step 33) SMF 320 stores the information related to Nue_Policy service.
Step 34) SMF 320 triggers towards PCF a Npcf_SMPolicyControl_Create Request message to retrieve SM policies for the user PDU session.
Step 35) PCF 330 triggers towards UDR a Nudr_Query Request message to retrieve the policy data for this user's PDU session.
Step 36) UDR 340 answers PCF with Nudr_Query Response message including the Subscriber Policy Data.
Steps 37 and 38) Based on the above Subscriber Policy Data, PCF 330 installs PCC rules for the session.
Steps 39 and 40) SMF 320 sends to UPF in the PFCP Session Establishment Request message the PDRs/FAR/QERs/URRs and the stored information (at Step 3) related to Nue_Policy service.
Step 41) UPF 100 stores the information related to Nue_Policy service.
Step 42) UPF 100 answers the message in Step 10 indicating successful operation.
Step 43) SMF 320 answers the message in Step 2 indicating successful operation.
Step 44) AMF 310 answers the message in Step 1 indicating successful operation.
Steps 45 and 46) UE 200 generates user plane traffic.
Step 47) UPF 100 inspects traffic and detects a UE security vulnerability. The detection can be based on internal logic at UPF, on a NWDAF instance collocated with the UPF instance or on an embedded or external Security SF, e.g. Packet Core Firewall (PCFW) product. As an example, PCFW might detect exposure of sensitive information vulnerability in a certain application which allows attackers to access internal data of the application.
Step 48) Based on the above, UPF 100 decides to trigger notification (through the Nue_Policy user notification service), e.g. to that device or to any device (model, OS version) which might have the same vulnerability. UPF triggers a Nue_Policy request (HTTPS POST) message towards UE (using the Nue_Policy service related information stored in Step 41 above) including the following information:
TrafficDescriptor, which includes the 5-tuples detected in Step 47 above.
RequestedPolicy, which indicates to UE the policy to be applied (e.g. user notification) and includes the message contents (e.g. information related to the detected UE security vulnerability).
Step 49) UE answers the message in Step 18 indicating successful operation.
Step 50) UE applies the requested policy (e.g. user notification) and displays a message to the user (e.g. information related to the detected UE security vulnerability).

A possible implementation of FIGS. 2 and 3 is as follows:
Step 11 and Step 31: N1 PDU Session Establishment Request {Indication of support for Nue_Policy service, Nue-Policy related information (Address information, information, supported policies (access control)}
Step 12 and Step 32: Nsmf PDU Session Create Request {Indication of support for Nue_Policy service, Nue Policy_Policy service related information (address information, supported policies (access control)}
Step 13 and Step 33: SMF stores the information related to Nue_Policy service
Step 14 and Step 34: Npcf_SmPolicyControl_Create Request
Step 15 and Step 35: Nudr_Query Request
Step 16 and Step 36: Nudr_Query Response {Subscriber Policy Data}
Step 17 and 37: PCF installs PCC rules
Step 18 and 38: Npcf_SMPolicyControl_Create Response
Step 19 and 39: SMF send to UPF the stored information related to Nue_Policy service
Step 20 and Step 40: PFCP Session Establishment Request {PDRs/FARs/QERs/URRs, Nue_Policy service related information}
Step 21 and Step 41: UPF stores the information related to Nue_Policy service
Step 22 and Step 42: PFCP Session Establishment Response
Step 23 and Step 43: Nsmf PDU Session Create Response
Step 24 and Step 44: N1 PDU Session Establishment Response
Step 25: Malicious application triggers DDoS attack
Step 45: UE generates user plane traffic
Step 26: Application traffic (Multiple TCP SYN messages)
Step 46: User plane traffic
Step 27: UPF detects DDOs attack and decides to trigger mitigation action at the source (UE)
Step 47: UPF inspects traffic, detects UE vulnerability and decides to trigger notification (through the Nue_Policy user notification service, e.g. to that device or to any device model (model, OS version) which might have the same vulnerability)
Step 28: Nue_Policy request (HTTPS Post) {Traffic Descriptor, Requested Policy (block)}
Step 48: Nue_Policy request (HTTPS Post) {Traffic Descriptor, Requested Policy (user notification, message)}
Step 29 and Step 39: 200 OK
Step 30: UE applies the requested policy (e.g. block) to the traffic matching Traffic Descriptor
Step 50: UE applies the requested policy (e.g. user notification)

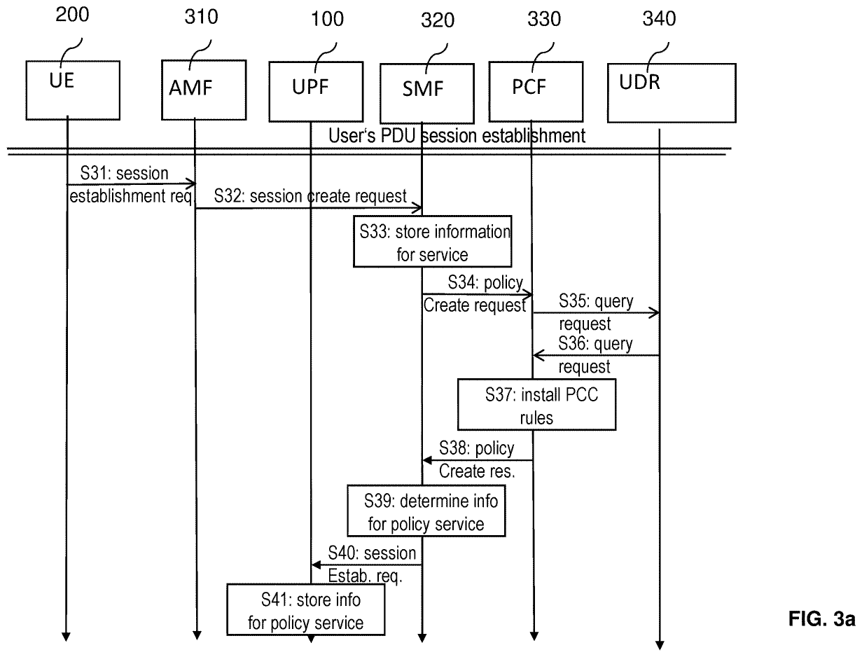

FIG. 4 shows some of the main steps carried out at the user plane entity 100 in the situation discussed in connection with FIGS. 2 and 3. In step 71 the user plane entity 100 receives a data packet traffic from a user equipment 200 which is connected to the network by way of example the traffic in step 26 or step 46 shown in FIGS. 2 and 3 respectively. In step 72 the user plane entity determines that the data packet traffic is a suspicious data packet traffic which can potentially cause harm. It may cause harm in the cellular network or elsewhere such as the Internet or at any destination attack point. As discussed above in steps 27 or 47 different options exist to determine that a harmful data traffic is present. In step 73 the user plane entity transmits a policy request to the user equipment which includes the traffic identifier of the identified data packet traffic and which includes a policy how to handle this data packet traffic at the user equipment. The policy request furthermore requests the application of the policy to the identified data packet traffic. This was discussed above in step 28 or 48.

As far as the user equipment is concerned user equipment transmits in step 81 the data packet traffic which is considered as a suspicious data packet traffic potentially causing harm. In step 82 the user equipment receives a policy request from a user plane entity including a traffic identifier and a policy how to handle the identified data packet traffic identified by the traffic identifier. Based on the received request in step S83 the user equipment applies the received policy to the identified data packet traffic.

From the above said some general conclusions can be drawn:

As far as the user plane entity 100 is concerned the policy transmitted to the user equipment 200 can contain the request for the user equipment to block the first data packet traffic which is considered harmful. The policy may also comprise the request for the user equipment to reduce a transmission time window for the identified data packet traffic.

The policy may furthermore comprise the request for the user equipment 200 to notify a user of the user equipment that the first data packet traffic is a suspicious data packet traffic considered as potentially causing harm.

The user plane entity 100 may furthermore determine that the first data packet traffic is a suspicious data packet traffic based at least on a traffic detection rule provided at the user plane entity or based on an indication received from the cellular network. Furthermore it is possible that the at least one detection rule will indicate a security attack for the cellular network including a passive attack for a cellular network or an active attack on the cellular network.

The user plane entity 100 can furthermore receive the policy how to handle the first data packet traffic from a session management entity of the network. Here it may receive the policy as part of the session establishment request which comprises an indication that the user equipment supports a policy service by which the user equipment is configured to react to the policy request including the policy and possible actions to be taken by the user equipment in reaction to the received policy.

The traffic identifier may include at least one source IP address, a destination IP address, a source port number, a destination port number and/or a used protocol. This can help to detect the data packet traffic unambiguously.

As far as the user equipment 200 is concerned the received policy can comprise the request for the user equipment to block the identified data packet traffic wherein the user equipment then blocks the identified traffic and does not transmit the data packet traffic to the cellular network in response to the received request.

The request may furthermore contain the request to reduce a transmission window for the identified data packet traffic, wherein user equipment produces the transmission time window in response to the request.

The policy can furthermore contain the request to notify the user of the user equipment 200 that the identified data packet traffic is a suspicious data packet traffic considered as potentially causing harm wherein the user of the user equipment is informed of a presence of the identified first data packet traffic in response to the received request.

The UE 200 may furthermore transmit an indication to the cellular network that the UE supports a policy service by which the user equipment is configured to react to the policy request received from a user plane entity wherein the indication includes the possible handlings of the data packet traffic and the user equipment. This was discussed above in steps 11 or 31.

The indication may be transmitted to an access and mobility management entity of the cellular network as can also be deduced from FIGS. 2 and 3.

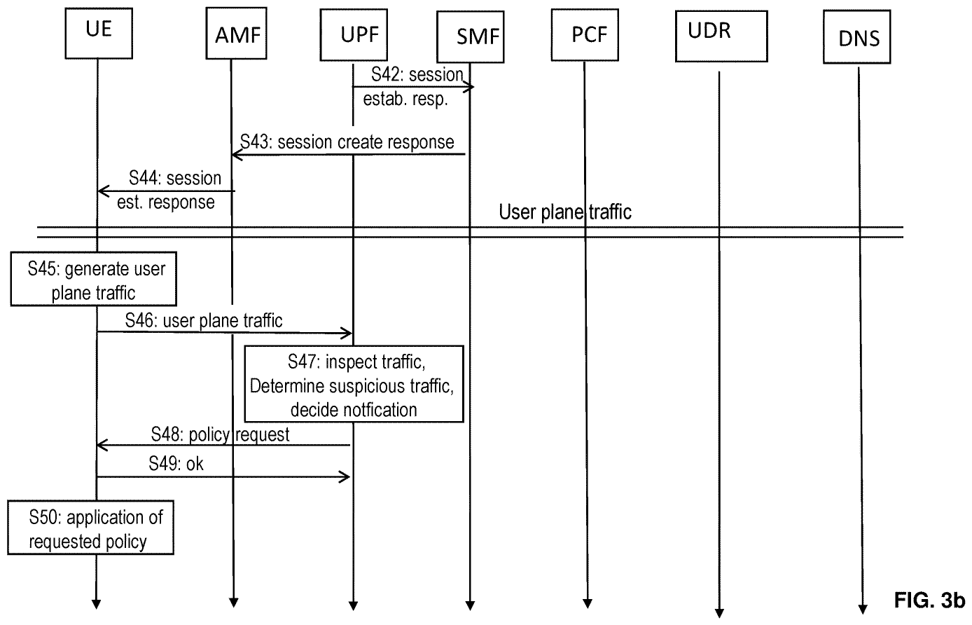

FIG. 5 shows a schematic architectural view of a user plane entity 100 which can carry out the above discussed steps. The user plane entity 100 comprises an interface 110 which is provided for transmitting user data or control messages to other entities and for receiving user data and control messages from other entities. The interface is especially qualified to receive and transmit the data traffic from the user equipment 200 and to instruct the user equipment how to handle a suspicious data traffic. The entity 100 furthermore comprises a processing unit 120 which is responsible for the operation of the entity 100. The processing unit 120 comprises one or more processors and can carry out instructions stored on a memory 130, wherein the memory may include a read-only memory, a random access memory, a mass storage, a hard disk or the like. The memory can furthermore include suitable program code to be executed by the processing unit 120 so as to implement the above described functionalities in which the entity is involved.

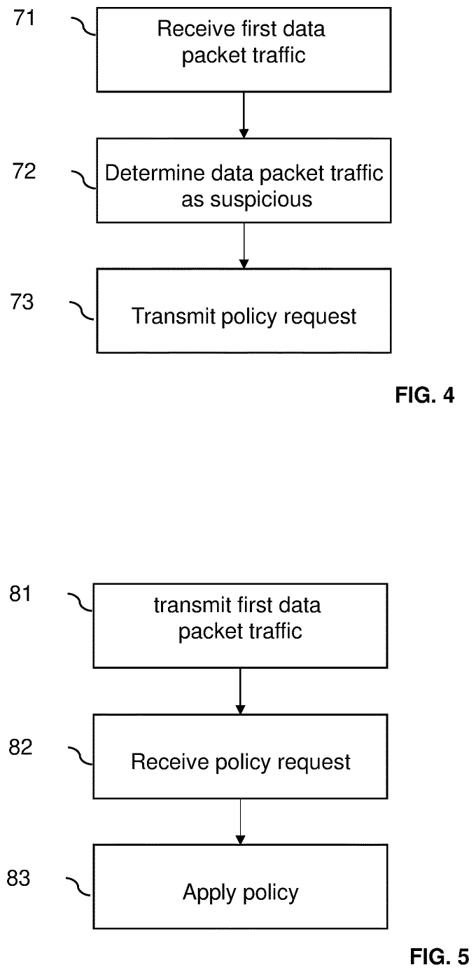

FIG. 6 shows a schematic architectural view of a user equipment 200 which can carry out the above discussed steps. The user equipment 200 comprises an interface 210 which is provided for transmitting user data or control messages to other entities and for receiving user data and control messages from other entities. The interface is especially qualified to receive and transmit the data traffic to the user plane entity 100 and to receive the instructions how to handle a suspicious data traffic. The user equipment 200 furthermore comprises a processing unit 220 which is responsible for the operation of the user equipment 200. The processing unit 220 comprises one or more processors and can carry out instructions stored on a memory 230, wherein the memory may include a read-only memory, a random access memory, a mass storage, a hard disk or the like. The memory can furthermore include suitable program code to be executed by the processing unit 220 so as to implement the above described functionalities in which user equipment 200 is involved.

The above-identified invention allows a mobile network operator to trigger traffic management actions to be executed at the UE following a principal of action in the first element of the chain, here the user equipment which is affected. It supports a time to mitigation which is closely aligned with the 5G risks such as 100 ms response time. Additionally, mitigation is applied at the source, the UE which also avoids the exhaustion of the radio access network resources. Furthermore, a user can be informed that the corresponding UE has a security issue.

1.-35. (canceled)

36. A method, carried out at a User Plane Function, UPF, handling data packet traffic in a cellular network, the method comprising:
receiving a first data packet traffic originating from a user equipment connected to the cellular network;
determining that the first data packet traffic is a suspicious data packet traffic considered as potentially causing harm;
transmitting a policy request to the user equipment, the policy request including a traffic identifier of the first data packet traffic and a policy how to handle the first data packet traffic at the user equipment, the policy request requesting an application of the policy to the first data packet traffic; and
the policy comprises the request for the user equipment to:
reduce a transmission time window for the first data packet traffic; and
notify a user of the user equipment that the first data packet traffic is a suspicious data packet traffic considered as potentially causing harm.

37. The method of claim 36, wherein it is determined that the first data packet traffic is a suspicious data packet traffic based on at least one traffic detection rule provided at the user plane entity or based on an indication received from the cellular network.

38. The method of claim 37, wherein the at least one detection rule indicates a security attack for the cellular network including a passive attack on the cellular network or an active attack on the cellular network.

39. The method of claim 36, wherein the policy how to handle the first data packet traffic is received from a session management entity of the cellular network.

40. The method of claim 39, wherein the policy is received as part of a session establishment request and comprises an indication that the user equipment supports a policy service by which the user equipment is configured to react to the policy request including the policy and possible actions to be taken by the user equipment in reaction to the received policy.

41. The method of claim 36, wherein the traffic identifier included in the policy request comprises at least one of a source IP address, a destination IP address, a source port number, a destination port number, and a used protocol.

42. A method, carried out a user equipment connected to a cellular network, the method comprising:
transmitting a first data packet traffic considered as suspicious data packet traffic and potentially causing harm in the cellular network to the cellular network;
receiving a policy request from a User Plane Function, UPF, user plane entity handling the first data packet traffic, the policy request including a traffic identifier of the first data packet traffic and a policy how to handle the first data packet traffic at the user equipment, the policy request requesting an application of the policy to the first data packet traffic;
applying the policy received in the request to the first data packet traffic; and
the policy comprising the request for the user equipment to:
reduce a transmission time window for the first data packet traffic, the transmission time window being reduced in response to the received request; and
notify a user of the user equipment that the first data packet traffic is a suspicious data packet traffic considered as potentially causing harm, the user of the user equipment being informed of a presence of the first traffic in response to the received request.

43. The method of claim 42, further comprising transmitting an indication to the cellular network that the user equipment supports a policy service by which the user equipment is configured to react to the policy request received from a user plane entity handling data packet traffic in the cellular network, the indication including possible handlings of the data packet traffic in the user equipment.

44. The method of claim 43, wherein the indication is transmitted to an access and mobility management entity of the cellular network.

45. A User Plane Function, UPF, configured to handle data packet traffic in a cellular network, the UPF configured to:
receive a first data packet traffic originating from a user equipment connected to the cellular network;
determine that the first data packet traffic is a suspicious data packet traffic considered as potentially causing harm;
transmit a policy request to the user equipment, the policy request including a traffic identifier of the first data packet traffic and a policy how to handle the first data packet traffic at the user equipment, the policy request requesting an application of the policy to the first data packet traffic; and
the policy comprises the request for the user equipment to:
reduce a transmission time window for the first data packet traffic; and
notify a user of the user equipment that the first data packet traffic is a suspicious data packet traffic considered as potentially causing harm.

46. The UPF of claim 45, wherein the policy comprises the request for the user equipment to reduce a transmission time window for the first data packet traffic.

47. The UPF of claim 45, wherein the policy comprises the request for the user equipment to notify a user of the user equipment that the first data packet traffic is a suspicious data packet traffic considered as potentially causing harm.

48. The UPF of claim 45, further configured to determine that the first data packet traffic is a suspicious data packet traffic based on at least one traffic detection rule provided at the user plane entity or based on an indication received from the cellular network.

49. The UPF of claim 48, wherein the at least one detection rule indicates a security attack for the cellular network including a passive attack on the cellular network or an active attack on the cellular network.

50. The UPF of claim 45, further being configured to receive the policy how to handle the first data packet traffic from a session management entity of the cellular network.

51. The UPF of claim 50, further configured to receive the policy as part of a session establishment request comprising an indication that the user equipment supports a policy service by which the user equipment is configured to react to the policy request including the policy and possible actions to be taken by the user equipment in reaction to the received policy.

52. The UPF of claim 45, wherein the traffic identifier included in the policy request comprises at least one of a source IP address, a destination IP address, a source port number, a destination port number, and a used protocol.

53. A user equipment connected to a cellular network, the user equipment configured to:
transmit a first data packet traffic considered as suspicious data packet traffic and potentially causing harm in the cellular network to the cellular network;
receive a policy request from a User Plane Function, UPF, handling the first data packet traffic, the policy request including a traffic identifier of the first data packet traffic and a policy how to handle the first data packet traffic at the user equipment, the policy request requesting an application of the policy to the first data packet traffic
apply the policy received in the request to the first data packet traffic; and
the policy comprising the request for the user equipment to:
reduce a transmission time window for the first data packet traffic, the user equipment begin configured to reduce the transmission time window in response to the received request; and
notify a user of the user equipment that the first data packet traffic is a suspicious data packet traffic considered as potentially causing harm, the user equipment begin configured to inform the user of the user equipment of a presence of the first traffic in response to the received request.

54. The user equipment of claim 53, further configured to transmit an indication to the cellular network that the user equipment supports a policy service by which the user equipment is configured to react to the policy request received from a user plane entity handling data packet traffic in the cellular network, the indication including possible handlings of the data packet traffic in the user equipment.

55. The user equipment of claim 54, further configured to transmit the indication to an access and mobility management entity of the cellular network.
